(19) United States
(12) Patent Application Publication
(10) Pub. No.: US 2015/0249578 A1
(43) Pub. Date: Sep. 3, 2015

(54) Method for Data Transmission.

(71) Applicant: Vodafone GmbH, Dusseldorf (DE)

(72) Inventor: Andreas Bothe, Hurth (DE)

(21) Appl. No.: 14/625,114

(22) Filed: Feb. 18, 2015

(30) Foreign Application Priority Data
Feb. 28, 2014 (DE) DE 102014203717.4

(51) Int. Cl. H04L 12/24; H04L 29/08; G06Q 20/08

(52) U.S. Cl. CPC H04L 41/50; G06Q 20/085; H04L 67/306

(57) ABSTRACT

The subject innovation relates to a method for providing data-based services via a terminal The method includes identifying a mobile terminal device of a user, identifying the terminal, linking the terminal to the mobile terminal device so that data-based services can be downloaded via the terminal and the costs associated with these data-based services can be charged to the mobile terminal device. The subject innovation also relates to a correspondingly adapted terminal and system. Data-based services may be requested via a terminal, and the costs may be charged to the mobile terminal device, without the mobile terminal device being involved in the provision of the data-based service.

### CROSS-REFERENCE TO RELATED APPLICATION

This application claims priority to German (DE) Patent Application No. 102014203717.4, filed on Feb. 28, 2014, the contents of which are incorporated by reference as if set forth in their entirety herein.

### BACKGROUND

U.S. Pat. Appln. No. 2013/0276036 A1 discloses a mobile entertainment system that is installed in a motor vehicle. The entertainment system is configured to wirelessly download and store content from an external source at an access point. The payment for the content is made by entering appropriate payment information.

The method described is impractical and is not conducive to the acceptance of paid data-based services.

### SUMMARY

The subject innovation relates to a method for data transmission, to an appropriately adapted terminal for data transmission, and to a system for data transmission.

Linking the terminal to the mobile terminal device makes it possible to invoice data-based services in a simple manner, for example, via the phone bill of the user of the mobile terminal device. Here, the mobile terminal device is not actively involved in the transaction relating to the data-based service.

As an alternative, the linking can also be stored on a server of an external service provider such as, for instance, a mobile telecommunications service provider. Thus, for example, it can be stored on this server that, e.g. the costs for music files that are downloaded by a certain terminal, which identifies itself with a terminal identifier, can be charged to the invoice of the mobile terminal device on the basis of the linking to said mobile terminal device. The terminal could be a multimedia device of an automobile, whereby this multimedia device could comprise a navigation device. Therefore, in this case, the external server checks the type of data being requested and, as a function of the requested data, checks whether the linking to the mobile terminal device of the user is established, so that the provision and transmission of the data can be invoiced, for example, together with the mobile phone invoice. If the requested data corresponds to a defined profile, the appertaining costs are invoiced via the mobile phone invoice.

In another alternative, the terminal can be a transportable navigation device that can be coupled to a vehicle (car, motorcycle, etc.). The navigation device can communicate, for example, via a Bluetooth module, with the ticket-dispensing machine of a parking garage. The ticket-dispensing machine makes it possible to purchase the ticket as a data-based service. The payment for the ticket can now be automatically made via the navigation device or else after the user of the navigation device has approved the purchase, for example, acoustically or via the display of the navigation device. After the activation, if applicable, an identifier of the navigation device and an identifier of the mobile terminal device (mobile phone, smartphone, etc.) of the user of the navigation device are transmitted, if applicable, in encrypted form. Moreover, the mobile telecommunications service provider of the user of the mobile terminal device is ascertained either via the identifier of the mobile terminal device (e.g., IMSI) or via additionally transmitted information. The ticket machine forwards the two linked identifiers to the mobile telecommunications service provider and invoices the costs for the parking at the same time as the transmission of the linked identifiers. The mobile phone invoice of the user can now be automatically charged for the costs on the basis of the identifier of the mobile terminal device. Additionally, information can be provided to the user about the charge, for example, by SMS. However, such an SMS can also be additionally employed in order to authorize the charge to the mobile phone invoice. In this case, for example, the user may send an SMS response in order to authorize the charge. Moreover, within the scope of the SMS response, the user could be authenticated, for instance, via a PIN.

As the examples show, the term, “terminal,” encompasses any unit that is suitable for transmitting or switching data-based services. Thus, for example, a tablet that does not have its own SIM card could download data-based services such as entertainment movies via the logical link to a mobile terminal device such as a smartphone with a USIM via the modality of a wireless connection, and these services could be invoiced together with the mobile phone invoice via the logical link, without a need to additionally provide, for example, credit card information. The logical link can be stored in the terminal or can be established by an external service provider. The external service provider can be, for instance, the mobile telecommunications service provider of the user of the mobile terminal device, or an independent entity. To ensure that all parties involved can transparently see to whom data is forwarded, and from whom data is received, so that the user can be charged for the costs incurred.

The term, “data-based services,” comprises the paid transmission of data (e.g., music, videos, etc.), as well as the exchange of data for purposes of processing a business transaction (e.g., parking garage ticket, tickets for public transportation, ordering of merchandise, etc.).

Before the linking between the terminal and the mobile terminal device is made, the linking is authorized by the user of the mobile terminal device. The authorization prevents a linking from taking place without the user's knowledge. The authorization can be made, for example, by entering a PIN on the mobile terminal device before, for instance, the IMSI is transmitted to the terminal in order to establish the linking. As an alternative, the user could register with his/her mobile telecommunications service provider in a protected area and could, for instance, identify one or more terminals that can be linked to one of his/her mobile terminal devices. Moreover, the user could specify which type of data-based services can be invoiced via the linking. Optionally, he or she could also define the security standard (automatically, SMS, PIN, etc.) via which, on the basis of the linking, a charging for the costs is allowed to take place.

In one embodiment, the mobile terminal device could be identified by an input on the mobile terminal device, and the terminal could be identified in that a first terminal identifier of the terminal is received by the mobile terminal device. The input can be made via a keyboard, acoustically, optically or else in some other suitable manner. Thus, the user of the mobile terminal device can use, for example, a menu to select the menu item “linking”, thereby identifying the mobile terminal device. The first terminal identifier can be received by a manual or acoustic input of a code on the mobile terminal device, whereby the code is associated with the terminal (e.g. sticker on the terminal). As an alternative, the first terminal identifier can also be received in the form of a message that is transmitted by the terminal as soon as a mobile terminal device is within a certain range. Moreover, the first terminal identifier can be detected by scanning an optical code. This code could be applied onto the terminal as a sticker or could be displayed on the terminal, for example, by a display.

In an alternative embodiment, the terminal can be identified by an input on the terminal, and the mobile terminal device can be identified in that a first terminal device identifier of the mobile terminal device is received by the terminal. This embodiment can be the minor image of the embodiment previously described, so that the above-mentioned identifying or receiving modalities can likewise be used here, as long as they make sense in terms of the terminal and/or the mobile terminal device. Moreover, after an activation, the terminal could send a request call if no linking has been stored. The mobile terminal device could transmit the first terminal device identifier in response to the request call. If applicable, this could be done after authorization by the user of the terminal device.

The linking could be carried out by associating a second terminal identifier of the terminal with a second terminal device identifier of the mobile terminal device. In one embodiment, the second terminal identifier of the terminal can correspond partially or entirely to the first terminal identifier. Moreover, in one embodiment, the second terminal device identifier of the mobile terminal device can correspond partially or entirely to the first terminal device identifier. As an alternative, within the scope of the linking procedure after the identification, further characteristic data can be exchanged that is suitable for the unambiguous charging of the costs. The terminal can be, for example, an installed navigation device that has multimedia capabilities and its own SIM card (connected device). In this case, the IMSI of the connected device could be used as the second terminal identifier and the IMSI of the mobile terminal device could be used as the second terminal device identifier. The association of the second terminal identifier of the terminal with the second terminal device identifier of the mobile terminal device could be stored in the terminal or in a linking unit. The linking unit could be, for example, a server or a part of the server of the mobile telecommunications service provider of the user of the mobile terminal device. The linking unit can be any networked device that permits a secure storage of the linking for purposes of charging the costs to the mobile terminal device. The linking unit can be administered by the mobile telecommunications service provider. As an alternative, the linking unit can also be administered by another external service provider.

In one embodiment, the association and thus the linking can be stored in the terminal. In this case, the method can also include:
automatically marking a request made via the terminal for the provision of the data-based service with the second terminal device identifier on the basis of this association;
transmitting the request to a data transmission unit;
providing the data-based service by the data transmission unit;
charging the costs for the data-based service to the mobile terminal device on the basis of the second terminal device identifier.

A request transmitted by the terminal, which in this case could be, for example, a navigation device with multimedia capabilities, asking for the transmission of specific video data is marked in the form of the second terminal device identifier by the navigation device in which the linking to a mobile terminal device is stored. The request thus marked with the linking is forwarded to a data transmission unit. The data transmission unit can forward the video data to the navigation device either directly or indirectly by contacting other service providers. Here, the data transmission unit is able to charge the costs for the transmitted video data to the user of the mobile terminal device, either by doing so itself or by forwarding a message to this effect that contains at least the second terminal device identifier.

In one embodiment, the association and thus the linking are stored in the linking unit. In this case, the method can also include:
transmitting a request marked with the second terminal identifier asking for the provision of the data-based service via the terminal;
checking on the basis of the second terminal identifier via a data transmission unit whether a link is stored in the linking unit;
providing the service via the data transmission unit;
charging the costs for the data-based service to the mobile terminal device on the basis of the second terminal identifier, insofar as a link is stored in the linking unit.

The terminal could receive an offer, for example, from an external device asking whether a data-based service is to be provided. A vehicle with a connected device might be, for instance, near an automatic carwash facility and could receive various offers for a car wash from an automatic control unit of the carwash facility, so that, via the display of the connected device or via acoustic instructions (e.g. Offer 5), the user of the vehicle requests the automatic control unit to accept Offer 5 (e.g. car wash with hot wax). The request is marked with the second terminal identifier. At the same time, the second terminal identifier indicates that a link could be stored in the linking unit, so that, via the data transmission unit, the automatic control unit queries the linking unit as to whether a link is stored for the second terminal identifier. If a link is stored, this is indicated to the automatic control unit. This can be done, for example, in such a way that the automatic control unit receives a standardized confirmation of the cost acceptance. The automatic control unit then activates the carwash facility for the vehicle and the costs for the car wash are charged to the mobile terminal device on the basis of the second terminal identifier. As a function of the structure of the data network and of the individual units, additional information (e.g. IP address, Access Point Name (APN)) can be transmitted, for instance, to indicate the linking or the possibility of the linking, and also to permit or trigger the establishment of contact with the data transmission unit and the linking unit.

As an alternative to the above-mentioned scenario, the automatic control unit could also provide its APN to the connected device, together with the offer. In response, the connected device then sends a message via the wireless cellular network to the data transmission unit, said message containing the second terminal identifier as well as the APN of the automatic control unit. On the basis of the linking unit that is integrated into the data transmission unit in this case, the data transmission unit checks whether a link exists. If a link is stored, this is indicated to the automatic control unit via the APN. This can be done, for example, in such a way that the automatic control unit receives a standardized confirmation of the cost acceptance. The automatic control unit then activates the carwash facility for the vehicle and the costs for the car wash are charged to the mobile terminal device on the basis of the second terminal identifier.

The automatic marking of the request with the second terminal device identifier can also be carried out as a function of the data-based service. Thus, on the basis of a list stored in the memory, the terminal could ascertain whether the data-based service is contained in a list. If the data-based service is listed, then the request is not marked with the second terminal device identifier. In this manner, for example, software updates of the terminal can be contained in the list as a data-based service, for example, if these updates have been paid for in advance as part of the package at the time of the purchase of the terminal. In this case, the marking via the second terminal device identifier is not carried out so that no costs are charged. In contrast, requests pertaining to other data-based services such as, for instance, the offer of a video portal that provides paid videos that can be downloaded are automatically marked with the second terminal device identifier so that the costs can be charged.

As an alternative, the costs for the data-based services on the basis of the second terminal identifier can be charged as a function of the IP address assigned to the data-based service or as a function of the Access Point Name (APN) assigned to the data-based service. Thus, the terminal can offer various data-based services such as free-of-charge IP radio or else a paid music service. The user selects the data-based service, and the request marked with the second terminal identifier is transmitted to the data transmission unit. The charging of the costs is now carried out as a function of the IP address of the selected data-based service. The data transmission unit checks, for example, on the basis of the APN of the data-based service, whether the data-based service is a paid service or a free one. In case of a paid data-based service, on the basis of the second terminal identifier, it is subsequently checked whether a link between the terminal and the mobile terminal device is stored in the linking unit. The costs are charged to the mobile terminal device if it is ascertained that a link exists. As an alternative, the data transmission unit can also check whether the IP address or APN is stored in a list, and the link is only checked if the IP address or APN is not stored in the list. The costs are thus charged to the mobile terminal device in all cases in which the IP addresses or APNs are not stored in the list. Here, the costs can comprise the costs for the provision of the connection to the appertaining IP address or APN as a separate data-based service, whereas the costs, for example, for activating a video file can be additionally invoiced.

In one embodiment, the linking could be associated with the presence of the mobile terminal device in a defined environment around the terminal. The terminal could, for example, mark a request to provide a data-based service if the mobile terminal device is within range of, for instance, a Bluetooth module of the terminal. In this manner, the linking is activated if the mobile terminal device is within range of the terminal. As an alternative, the mobile terminal device can also detect the terminal, and can send an activation message to the terminal in order to activate the linking. As an alternative, the linking can also be automatically deleted as soon as the mobile terminal device is no longer in the defined environment of the terminal In this manner, the risk of manipulation of the link or use of the link by unauthorized persons can be reduced. Another approach involves the automatic deletion of the link in those cases in which the user of the mobile terminal device is not regularly in the vicinity of the terminal or else is only there one time. This would be the case, for instance, with a rental car that has, for example, a navigation device that is linked to the mobile terminal device for the duration of the rental agreement.

In an alternative embodiment, the method also includes:
sending an activation message to the mobile terminal device and/or to the terminal as soon as data-based services are requested whose costs are charged to the mobile terminal device because of the linking of the terminal to the mobile terminal device;
providing the data-based services after a confirmation message has been received from the mobile terminal device and/or from the terminal.

During the checking as to whether a link is present, or as soon as a request is received, indicating the linking of a terminal to a mobile terminal device, the data transmission unit and/or the linking unit can send an activation message to the mobile terminal device and/or to the terminal. The activation message can include , for example, an SMS that is sent to the terminal and/or to the mobile terminal device. The user of the mobile terminal device or of the terminal is thus informed that a data-based service has been requested whose costs are to be charged to the mobile terminal device. The SMS can contain additional automatic response fields (confirm yes/no) with which the user can send a confirmation message to the data transmission unit and/or to the linking unit. The activation message and the confirmation message may be useful if the user of the data-based service, and the user of the mobile terminal device are not the same. In this case, it would be useful for the activation message to be sent to the mobile terminal device. As an alternative, however, the sending of the confirmation message could also be associated with the input of an authorization code in order to make any manipulation more difficult. Moreover, the activation message could be used to obtain details about the requested data-based service. Thus, for instance, a multimedia system installed in a vehicle could be used by passengers in the back seat to download video data. The driver of the vehicle is then informed via the activation message about the details of the request via the terminal and he or she can then confirm the activation as a function of the contents.

In another embodiment, the method can also include:
receiving a transmission request of a presentation unit by the terminal;
coupling the presentation unit to the terminal so that the presentation unit is able to download data-based services via the terminal and the costs associated with these data-based services are charged to the mobile terminal device.

The presentation unit can be a tablet, a laptop, a display or any other device that is capable of playing or displaying data-based content (video data, music data, etc.). Therefore, such a presentation unit can be given access to data-based services via the terminal, without the presentation unit itself being capable of connecting to the data transmission unit in a given situation. The presentation unit can be, for example, a tablet that a passenger in a vehicle is using. The tablet does not have its own SIM card, as a result of which a connection to the Internet cannot be made during the drive. However, the tablet can connect to the Internet via Wi-Fi that is made available by the terminal (e.g. navigation device). The terminal now permits the forwarding of a request pertaining to data-based services, whereby the costs for the data-based service can be charged to the mobile terminal device on the basis of the linking between the terminal and the mobile terminal device(smartphone of the driver). In this manner, for example, children in the back seat of a vehicle can download entertainment programs during a trip. The father or mother of the children to whom the mobile terminal device belongs, as described above, receives information, for example, about the requested video data via SMS on the screen of the navigation system and he or she can activate this by sending a confirmation message. A list of presentation units and appertaining identification features can be stored in the terminal in order to prevent unauthorized users from being able to request data-based services via the terminal.

The subject innovation also relates to a terminal, whereby the terminal is configured to permit the linking to a mobile terminal device of a user, so that data-based services can be downloaded via the terminal and the costs associated with the data-based services can be charged to the mobile terminal device.

Consequently, the terminal can permit access to data-based services without the mobile terminal device being actively used. The terminal is also configured so that all of the method steps described above can be carried out on the terminal.

The subject innovation also relates to a system having a terminal, a mobile terminal device and a data transmission unit, whereby the system is configured to identify the mobile terminal device and the terminal, and the system is also configured to carry out a linking of the terminal to the mobile terminal device on the basis of the identification of the mobile terminal device and of the terminal, and the system is also configured to download data-based services via the terminal and to charge the mobile terminal device for the costs associated with these data-based services.

The system is also configured to carry out all of the above-mentioned method steps pertaining to the system. The data transmission unit can be any computing unit that is available in a data network and that can make a connection with the terminal directly or via switching units using one or more wireless or hard-wired data transmission technologies. The system can also have a linking unit in which the link between the terminal and the mobile terminal device can be stored. The linking unit can be, for example, a data storage unit that is part of the data transmission unit. As an alternative, the linking unit can be, for example, an independent server on which the link between the mobile terminal device and the terminal is stored. The data transmission unit and/or the linking unit can be made available, for instance, by the communications service provider that is responsible for the invoicing of the mobile terminal device.

### BRIEF DESCRIPTION OF THE DRAWINGS

These and other aspects of the subject innovation are shown in detail in the figures as follows:

FIG. 1 is a schematic diagram of a method for providing data-based services;

FIG. 2 is a schematic view of the linking according to a first embodiment;

FIG. 3 is a schematic view of the linking according to a second embodiment;

FIG. 4 is a system according to a first embodiment;

FIG. 5 is a system according to a second embodiment;

FIG. 6 is a schematic view of the linking according to a third embodiment; and

FIG. 7 is an embodiment of a terminal.

### DETAILED DESCRIPTION OF THE SPECIFIC EMBODIMENTS

FIG. 1 shows a schematic diagram of a method for providing data-based services. At block 10, a mobile terminal device 120 of a user is identified. The mobile terminal device 120 can be a mobile phone, a smartphone, a mobile computer or any other mobile terminal device that is capable of making use of data-based services in one or more data networks that are connected to each other via a wireless or hard-wired connection, said data-based services being invoiced to the user of the mobile terminal device on the basis of the device identifier. At block 15, a terminal 112, 612 is identified. The terminal 112, 612 can be any device via which the data-based services can be requested. The terminal 112, 612 can especially be a vehicle terminal in the form of a navigation device or a multimedia device that can be coupled to a vehicle. The terminal 112, 612 can be uncoupled, as a result of which the vehicle terminal can be used in various vehicles. At block 20, the linking 127 of the terminal 112, 612 with the mobile terminal device 120 is made. The linking 127 is carried out in such a way that, when the data-based services are requested via the terminal 112, 612, the mobile terminal device 120 can be identified so unambiguously that costs incurred by the use of the data-based services can be charged to the mobile terminal device 120 or rather, to the user of the mobile terminal device. The term, “data-based services,” includes all services that can be carried out or initiated by the transmission of data.

Below, examples will describe how a link 127 is established between a mobile terminal device 120 such as, for example, a cell phone and a terminal 112, 612 such as, for example, a connected device in a vehicle such as a car.

### Example 1

The cell phone can be identified by entering the phone number of the cell phone of the user on the connected device, that is to say, as a menu item in the software of the connected device. Through the input on the connected device, the connected device is identified at the same time. This logical connection or linking between the cell phone of the user and the unambiguous identifier of the connected device is stored either in the connected device or in a database of a linking unit 130 via a data transmission.

### Example 2

An SMS is sent from the cell phone of the user to the connected device via a concrete application (APP) on the cell phone by entering the unambiguous identifier of the connected device. The connected device can display this unambiguous identifier as a menu item on its screen. The linking 127 between the cell phone of the user and the unambiguous identifier of the connected device is stored in a database of a linking unit 130 or in the connected device.

### Example 3

An SMS is generated with the cell phone of the user via a QR code, whereby, after a menu item of the connected device has been selected, the QR code is shown on the display of the connected device, said QR code comprising an unambiguous association with the SIM of the connected device. The linking 127 between the cell phone of the user and the unambiguous identifier of the connected device is stored in a database of a linking unit 130 or else in the connected device.

### Example 4

An SMS or IP-based request is generated by the cell phone of the user via an NFC interface. After a menu item of the connected device is selected or is present, an unambiguous identifier is sent via NFC so that an app on the cell phone uses this to generate the requisite SMS or IP-based request for association with the connected device. The linking 127 between the cell phone of the user and the unambiguous identifier of the connected device is stored in a database of a linking unit 130 or in the connected device.

### Example 5

An SMS or IP-based request from the cell phone of the user is generated via a Bluetooth interface. After a menu item of the connected device has been selected, or is present, an unambiguous identifier is sent via Bluetooth (similar to coupling during hands-free telephony, except here with an eye towards generating the SMS or IP-based request in the cell phone), so that an app on the cell phone uses this to generate the requisite SMS or IP-based request for linking to the connected device. The linking 127 between the cell phone of the user and the unambiguous identifier of the connected device is stored in a database of a linking unit 130 or in the connected device.

### Example 6

An SMS with concrete syntax is manually entered via the cell phone of the user (for example, send “Logiclink SIM cell phone to SIM connected device” to target phone number). The linking 127 between the cell phone of the user and the unambiguous identifier of the connected device is stored in a database of a linking unit 130 or in the connected device.

### Example 7

A mobile device connects to the connected device via Wi-Fi. This mobile device can be a device with or without its own SIM, and it does not necessarily have to be the mobile terminal device 120 that is logically connected for purposes of the invoicing (e.g. the daughter's tablet that only has Wi-Fi). For purposes of the linking 127, the SIM number of the cell phone of the user is entered on a website generated locally in the vehicle via software of the connected device. The logical connection between the cell phone of the user and the unambiguous identifier of the connected device is stored either in the connected device or in a database of a linking unit 130 via a data transmission.

### Example 8

A mobile device connects to the connected device via Wi-Fi. This mobile device can be a device with or without its own SIM, and may not be the mobile terminal device 120 that is logically connected for purposes of the invoicing (e.g. the daughter's tablet that only has Wi-Fi). For purposes of the linking 127, the SIM number of the cell phone of the user is entered into an app that is running on the mobile device and that communicates with the connected device. The logical connection or linking 127 between the cell phone of the user and the unambiguous identifier of the connected device is stored either in the connected device or in a database of a linking unit 130 via a data transmission.

### Example 9

A mobile device connects to the connected device via Wi-Fi. This mobile device can be a device with or without its own SIM, and may not be the mobile terminal device 120 that is logically connected for purposes of the invoicing (e.g. the daughter's tablet that only has Wi-Fi). For purposes of the linking 127, the SIM number of the cell phone of the user is entered on a website landing page that is accessed via the Wi-Fi interface of the connected device (that is to say, mobile telecommunication via a SIM installed in the connected device). The linking 127 between the cell phone of the user and the unambiguous identifier of the connected device is stored either in the connected device or in a database of a linking unit 130 via a data transmission.

### Example 10

A mobile device connects to the connected device via Wi-Fi. This mobile device can be a device with or without its own SIM, and it may not be the mobile terminal device 120 that is logically connected for purposes of the invoicing (e.g. the daughter's tablet that only has Wi-Fi). For purposes of the linking 127, the SIM number of the cell phone of the user is entered into an app that communicates with an external server via the Wi-Fi interface of the connected device (that is to say, mobile telecommunication via a SIM installed in the connected device). The linking 127 between the cell phone of the user and the unambiguous identifier of the connected device is stored either in the connected device or in a database of a linking unit 130 via a data transmission.

In order to further secure the method, an authorization can be provided, which is described below with reference to several examples. In one example, it may be possible to enter an authorization PIN that was sent via SMS to the cell phone of the user in order to authorize invoicing via Operator Billing for the service that has been or will be provided. The methods for entering the authorization PIN can be combined with the application cases in order to establish the logical linking, but the relationship with the intended logical linking is unambiguous.

### Example 11

Input of the authorization PIN on the connected device, that is to say, as a menu item in the software of the connected device. The authorization PIN for this case is stored either in the connected device or in a database, for example, as part of the linking unit 130, via a data transmission or SMS.

### Example 12

Input of the authorization PIN via a concrete app on the cell phone. The logical connection or linking 127 of the SIM of the cell phone of the user and of the SIM of the connected device is established by the app, by a logical continuation of the method described above. The authorization PIN for this case is stored either in a database, for example, as part of the linking unit 130, via a data transmission or SMS, or it is stored in the connected device.

### Example 13

An SMS with concrete syntax is manually entered via the cell phone of the user (for example, send “authorization PIN for Logiclink “XYZ” to target phone number). The authorization PIN for this case is stored in a database, for example, as part of the linking unit 130, via an SMS, or it is stored in the connected device.

### Example 14

Input of the authorization PIN on a website generated locally in the vehicle via software of the connected device. The website is displayed on a mobile device that is connected to the connected device via Wi-Fi. The authorization PIN for this case is stored either in the connected device or else in a database, for example, as part of the linking unit 130, via a data transmission or SMS.

### Example 15

Input of the authorization PIN on an app that communicates with the software of the connected device. The app runs on a mobile device that is connected to the connected device via Wi-Fi. The authorization PIN for this case is stored either in the connected device or else in a database, for example, as part of the linking unit 130, via a data transmission or SMS.

### Example 16

Input of the authorization PIN on a website landing page that is accessed via the Wi-Fi interface of the connected device (that is to say, mobile telecommunication via a SIM installed in the connected device). The website is displayed on a mobile device that is connected to the connected device via Wi-Fi. The authorization PIN for this case is stored in a database, for example, as part of the linking unit 130, via a data transmission or SMS, or in the connected device.

### Example 17

Input of the authorization PIN in an app that communicates with an external server via the Wi-Fi interface of the connected device (that is to say, mobile telecommunication via a SIM installed in the connected device). The app runs on a mobile device that is connected to the connected device via Wi-Fi. The authorization PIN for this case is stored in a database, for example, as part of the linking unit 130, via a data transmission or SMS, or else in the connected device.

Moreover, the possibility exists to actively terminate the logical linking to all of the contact sites that are also used for entering the authorization PIN.

### Example 18

Active termination of the logical linking on the connected device, that is to say, as a menu item in the software of the connected device.

### Example 19

Active termination of the logical linking via a concrete app on the cell phone, by a logical continuation of the method described above.

### Example 20

Active termination of the logical linking via an SMS with concrete syntax that is to be entered manually via the cell phone of the user (for example, send “stop Logiclink “XYZ” to target phone number).

### Example 21

Active termination of the logical linking via the website is generated locally in the vehicle via software of the connected device. The website is displayed on a mobile device that is connected to the connected device via Wi-Fi.

### Example 22

Active termination of the logical linking in an app that communicates with the software of the connected device. The app runs on a mobile device that is connected to the connected device via Wi-Fi.

### Example 23

Active termination of the logical linking on a website landing page that is accessed via the Wi-Fi interface of the connected device (that is to say, mobile telecommunication via a SIM installed in the connected device).

### Example 24

Active termination of the logical linking in an app that communicates with an external server via the Wi-Fi interface of the connected device (that is to say, mobile telecommunication via a SIM installed in the connected device). The app runs on a mobile device that is connected to the connected device via Wi-Fi.

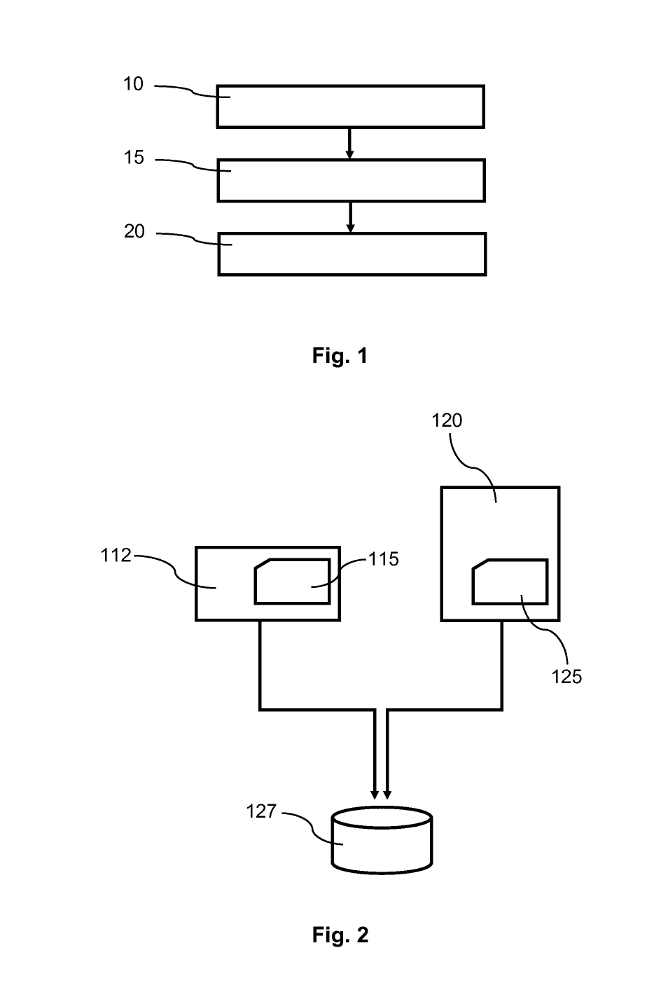

FIG. 2 shows a schematic view of the linking 127 according to a first embodiment. A terminal 112 has an identification module 115 that permits the unambiguous identification of the terminal 112. An unambiguous terminal identifier (name and address of the owner of the terminal) is stored in the identification module 115. A mobile terminal device 120 likewise has an identification module 125 that permits the unambiguous identification of the mobile terminal device. An unambiguous terminal device identifier is stored in the identification module 125. In this case, the identification module 125 is a SIM card and the terminal identifier is the IMSI that is stored on the SIM card. A linking 127 of the terminal 112 and of the mobile terminal device 120 is carried out in that the terminal identifier and the terminal device identifier are both stored in the terminal. The terminal 112 can thus forward the terminal device identifier together with the terminal identifier, so that costs for data-based services that are downloaded via the terminal can be charged to the mobile terminal device 120 via the linking 127.

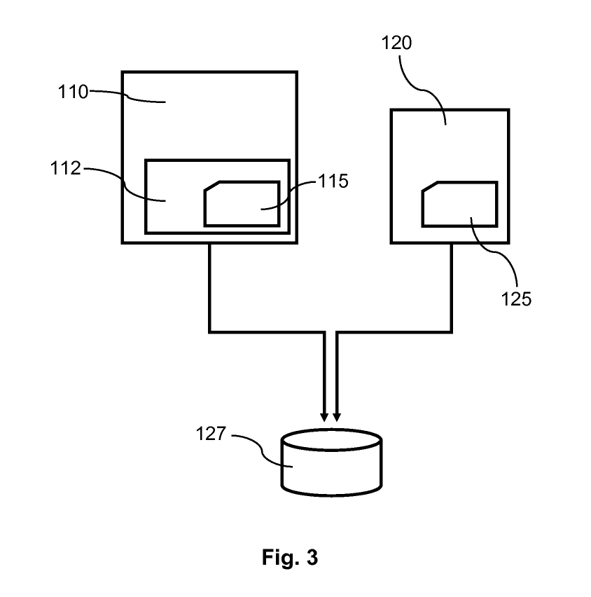

FIG. 3 shows a schematic view of the linking 127 according to a second embodiment. A terminal 112 is coupled to a vehicle 110 and it has an identification module 115 that permits the unambiguous identification of the terminal 112. In this case, the terminal is a connected device in which the identification module 115 is present in the form of a SIM card. The IMSI on the SIM card is an unambiguous terminal identifier that permits the identification of the connected device. A mobile terminal device 120 likewise has an identification module 125 that permits the unambiguous identification of the mobile terminal device. An unambiguous terminal device identifier is stored in the identification module 125. In this case, the identification module 125 is a USIM card and the terminal device identifier is the IMSI that is stored on the USIM card. The linking 127 of the connected device and of the mobile terminal device 120 is carried out in that the terminal identifier and the terminal device identifier are both stored on the SIM card of the connected device. Thus, the connected device can forward the terminal device identifier together with the terminal identifier so that costs for data-based services that are downloaded via the connected device can be charged to the mobile terminal device 120 via the link 127.

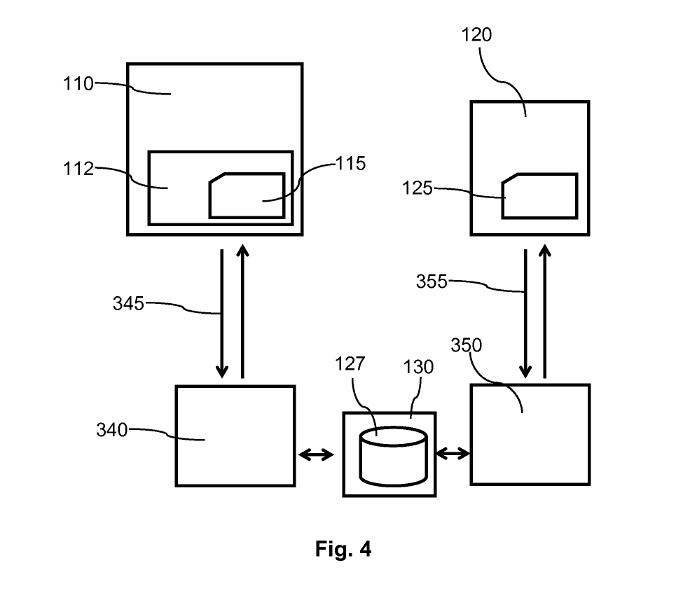

FIG. 4 shows a system according to a first embodiment. A terminal 112 is coupled to a vehicle 110 and it has an identification module 115 that permits the unambiguous identification of the terminal 112. In this case, the terminal is a connected device (e.g. a multimedia-capable navigation device) in which the identification module 115 is present in the form of a SIM card. The IMSI on the SIM card is an unambiguous terminal identifier that permits the identification of the connected device. A mobile terminal device 120 likewise has an identification module 125 that permits the unambiguous identification of the mobile terminal device 120. An unambiguous terminal device identifier is stored in the identification module 125. In this case, the identification module 125 is a USIM card, and the terminal device identifier is the IMSI that is stored on the USIM card. The linking 127 of the connected device and of the mobile terminal device 120 is carried out in that the terminal identifier and the terminal device identifier are both stored in a linking unit 130. Thus, the connected device can forward the terminal identifier to a data transmission unit 340, together with an address of the linking unit 130, via session data 345. The data transmission unit 340 queries the linking unit 130 as to whether a link 127 exists. The linking unit 130 informs a billing unit 350 that, as a result of the linking, costs are to be charged to the mobile terminal device 120. Invoice data 355 or invoice information is forwarded to the mobile terminal device 120 by SMS or by an IP-based modality so that, after an activation SMS has been received, the costs can be charged to the mobile terminal device 120. Subsequently, the data pertaining to the data-based service, along with session data 345, is transmitted by the data transmission unit 340 to the connected device.

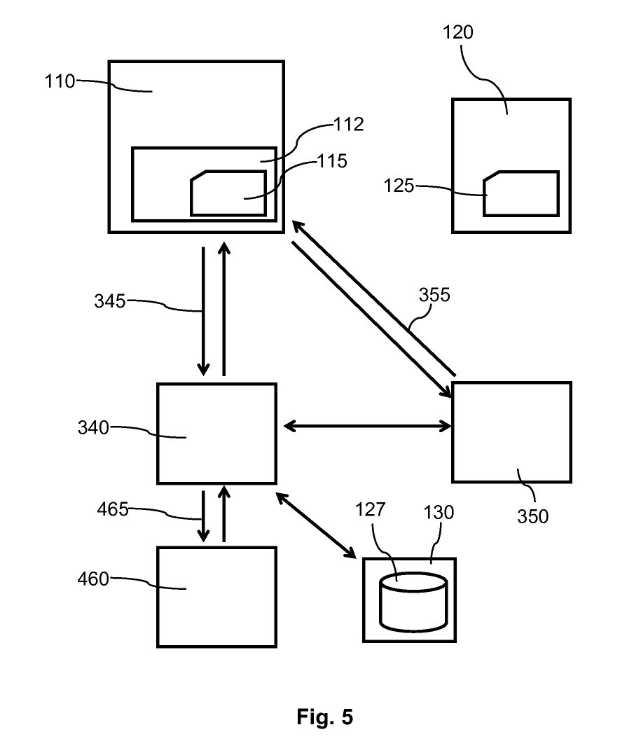

FIG. 5 shows a system according to a second embodiment. A terminal 112 is coupled to a vehicle 110 and it has an identification module 115 that permits the unambiguous identification of the terminal 112. In this case, the terminal is a connected device (portable navigation device with multimedia functionalities) in which the identification module 115 is present in the form of a SIM card. The IMSI on the SIM card is an unambiguous terminal identifier that permits the identification of the connected device. A mobile terminal device 120 likewise has an identification module 125 that permits the unambiguous identification of the mobile terminal device 120. An unambiguous terminal device identifier is stored in the identification module 125. In this case, the identification module 125 is a USIM card and the terminal identifier is the IMSI that is stored on the USIM card. A linking 127 of the terminal 112 and of the mobile terminal device 120 is carried out in that the terminal identifier and the terminal device identifier are both stored in the storage area of a linking unit 130. The linking unit is, for example, a server with a memory unit. Thus, the connected device can forward the terminal identifier to a data transmission unit 340, together with an address of the linking unit 130, via session data 345. However, the terminal identifier is transmitted with the address of the linking unit 130 to the data transmission unit if no telematic data 465 is requested from a telematic service provider 460. The APN of the telematic service provider 460 is stored in the connected device so that an unambiguous association is possible as a function of the requested data. The data transmission unit 340 now decides on the basis of the address of the linking unit, which indicates a link 127, whether the linking unit 130 is queried as to whether a link 127 exists. The linking unit 130 informs the data transmission unit 340 that a link 127 exists and informs the data transmission unit 340 about the address of a billing unit 350 and, if applicable, about required authentication data. The data transmission unit subsequently informs the billing unit 350 that, as a result of the linking, costs are to be charged to the mobile terminal device 120. Invoice data 355 is forwarded to the connected device by SMS or by an IP-based modality. The user of the connected device can now authorize the charging of the costs by sending an activation SMS via the connected device. Moreover, the data pertaining to the data-based service, along with session data 345, is transmitted by the data transmission unit 340 to the connected device.

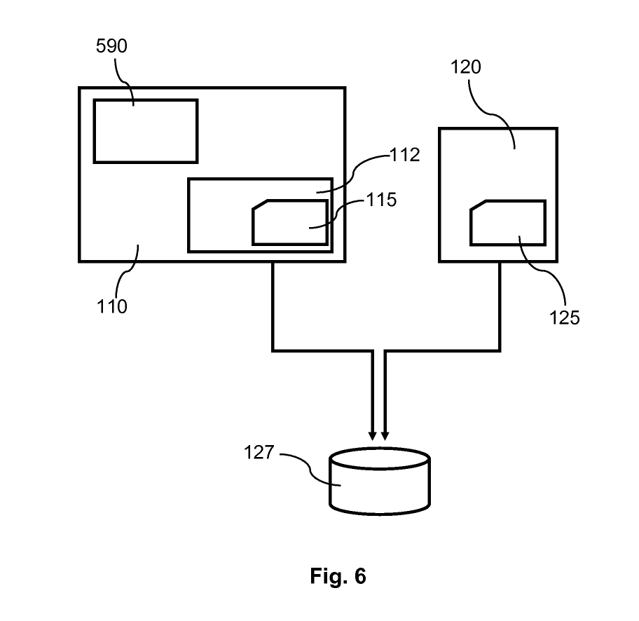

FIG. 6 shows a schematic view of the linking according to a third embodiment. A terminal 112 is coupled to a vehicle 110 and it has an identification module 115 that permits the unambiguous identification of the terminal 112. In this case, the terminal 112 is a connected device (installed multimedia system with navigation functionality) that is present in the identification module 115 in the form of a SIM card. The IMSI on the SIM card is an unambiguous terminal identifier that permits the identification of the connected device. A mobile terminal device 120 likewise has an identification module 125 that permits the unambiguous identification of the mobile terminal device 120. An unambiguous terminal device identifier is stored in the identification module 125. In this case, the identification module 125 is a USIM card, and the terminal device identifier is an IMSI of the mobile terminal device 120 that is stored on the USIM card. A linking 127 of the connected device and of the mobile terminal device 120 is carried out in that the terminal identifier and the terminal device identifier are both stored on the SIM card or in another place in the connected device. The connected device can thus forward the terminal device identifier together with the terminal identifier. A presentation unit 590 is registered in the connected device and is connected to the connected device via Wi-Fi that is made available by the connected device. Via the connected device, a user of the presentation unit 590 can now download music data from a data transmission unit 340 (not shown here) that is made available by the mobile telecommunications service provider of the user of the mobile terminal device 120 or by another service provider. On the basis of the linking 127 of the terminal identifier and of the terminal device identifier, the costs for the transmission of the music data can be charged to the mobile terminal device 120 via a billing unit 350 which is likewise operated by the mobile telecommunications service provider or by another service provider and to which the data transmission unit 340 is connected.

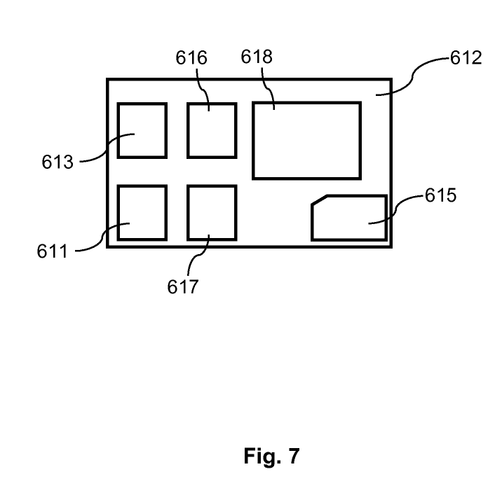

FIG. 7 shows an embodiment of a terminal 612. The terminal includes an input unit 611 with which, for example, the linking can be carried out by entering a terminal device identifier of a mobile terminal device 120. Moreover, via the input unit 611, data-based services can be requested via the terminal 612. The terminal 612 includes a storage unit 613 in which, for example, the linking 127 between the terminal and the mobile terminal device 120 is stored. The administration of the functionalities of the terminal 612 is carried out via a control unit 616 of the terminal 612. The control unit 616 includes, for example, a processor that is suitable for running the software to operate the terminal 612. The terminal 612 also includes a data exchange unit 617. The data exchange unit 617 permits the data exchange with external units, for example, via GSM, UMTS and/or LTE. Moreover, the data exchange unit 617 permits the exchange of data with a presentation unit 590, for example, via Wi-Fi technology. Finally, the terminal also includes a presentation unit 618. The presentation unit 618 includes a screen that can also be suitable for making entries. Data-based services can be presented to the respective user via the presentation unit 618.

The embodiments shown here constitute merely examples of the present subject innovation and therefore are not intended to be construed in a limiting fashion. Alternative embodiments considered by one of ordinary skill in the art are likewise encompassed by the scope of protection of the present subject innovation.

1-15. (canceled)

16. A method for providing data-based services via a terminal comprising:
identifying a mobile terminal device of a user;
identifying the terminal; and
linking the terminal to the mobile terminal device so that data-based services can be downloaded via the terminal and costs associated with the data-based services can be charged to the mobile terminal device.

17. The method according to claim 16, wherein the terminal can be coupled to a vehicle.

18. The method according to claim 16, comprising authorizing the linking by the user.

19. The method according to claim 16, wherein the mobile terminal device is identified by an input on the mobile terminal device, and the terminal is identified by a first terminal device identifier being received by the mobile terminal device.

20. The method according to claim 16, wherein the terminal is identified by an input on the terminal, and the mobile terminal device is identified by a first terminal device identifier being received by the terminal.

21. The method according to claim 16, wherein the linking is carried out by associating a second terminal identifier of the terminal with a second terminal device identifier of the mobile terminal device, and storing a corresponding association in the terminal or a linking unit.

22. The method according to claim 21, wherein the association is stored in the terminal, and the method comprises:
automatically marking a request made via the terminal for provision of the data-based services with the second terminal device identifier based on the association;
transmitting the request to a data transmission unit;
providing the data-based services by the data transmission unit; and
charging costs for the data-based services to the mobile terminal device based on the second terminal device identifier.

23. The method according to claim 21, wherein the association is stored in the linking unit, and the method comprises:
transmitting a request marked with the second terminal identifier asking for provision of the data-based services via the terminal;
checking, based on the second terminal identifier, via a data transmission unit whether a link is stored in the linking unit;
providing the data-based services via the data transmission unit; and
charging costs for the data-based services to the mobile terminal device based on the second terminal identifier and a link stored in the linking unit.

24. The method according to claim 22, wherein automatic marking of the request with the second terminal device identifier is carried out as a function of the data-based services.

25. The method according to claim 22, wherein automatic marking of the request with the second terminal device identifier is carried out as a function of an IP address assigned to the data-based services, or as a function of an access point assigned to the data-based services.

26. The method according to claim 16, wherein the linking is associated with a presence of the mobile terminal device in a defined environment around the terminal.

27. The method according to claim 26, comprising:
sending an activation message to the mobile terminal device and/or to the terminal as soon as data-based services are requested, wherein costs of the data-based services are charged to the mobile terminal device based on linking of the terminal to the mobile terminal device; and
providing the data-based services after a confirmation message has been received from the mobile terminal device and/or from the terminal.

28. The method according claim 16, comprising:
receiving a transmission request of a presentation unit by the terminal;
coupling the presentation unit to the terminal so that the presentation unit is able to download data-based services via the terminal, and wherein costs associated with the data-based services are charged to the mobile terminal device.

29. A terminal that permits linking to a mobile terminal device of a user, so that data-based services can be downloaded via the terminal, and wherein costs associated with the data-based services can be charged to the mobile terminal device.

30. A system having a terminal, a mobile terminal device and a data transmission unit, whereby the system identifies the mobile terminal device and the terminal, carries out a linking of the terminal to the mobile terminal device based on identification of the mobile terminal device and of the terminal, downloads data-based services via the terminal, and charges the mobile terminal device for costs associated with the data-based services.
